(19) United States
(12) Patent Application Publication
(10) Pub. No.: US 2009/0151827 A1
(43) Pub. Date: Jun. 18, 2009

(54) Removable protective cover door guard

(76) Inventor: Kevin Thompson, Arlington, VA (US)

Correspondence Address: NIXON & VANDERHYE, PC, 901 NORTH GLEBE ROAD, 11TH FLOOR, ARLINGTON, VA, 22203, US

(21) Appl. No.: 12/000,724

(22) Filed: Dec. 17, 2007

(51) Int. Cl. B65D 65/02; E06B 9/00; B60J 5/04; E06B 3/00

(52) U.S. Cl. 150/154; 160/368.1; 49/502; 49/506

(57) ABSTRACT

A device for the protection of vehicle door interiors while transporting things that might damage the door is provided. In exemplary form, the device may be removably installed on the interior of vehicle doors and at least temporarily secured in place while the door is open. Closing the door may further serve to secure the device in place, preventing it from being accidentally dislodged.

### FIELD

The technology herein generally relates to protection for the interior of vehicle doors while transporting things that might damage the door. More specifically, the technology herein relates to removable, protective covers that can be removably installed on the interior of vehicle doors and at least temporarily secured in place while the door is open.

### BACKGROUND AND SUMMARY

Although the passengers of a motor vehicle are typically people, it is not uncommon for cars, trucks, SUVs, etc., to be used for transport of a variety of other things. People often load up boxes, plants, pets, and any number of other items (such as when moving their personal belongings from one place to another). Often, these items are not packaged properly, not designed for transport in vehicles, and, in the case of pets, not entirely controllable while driving the vehicle.

While vehicle interiors are made to be fairly durable, they are typically not designed to be subjected to abuse from pets and rough container edges. Thus, the interiors can be damaged when transporting cargo that can bump or rub against the interiors of its doors, rake the doors with claws or even gnaw on the doors. While a number of devices have been developed to protect the outside of a vehicle's doors from incidental impact, fewer innovations deal with the protection of the interior of the vehicle. Even though incidental damage to a vehicles interior may seem less likely (since it is protected by the car itself) many people find that, over the years, the interiors of their cars become rather roughed up. A non-exhaustive list of risks includes:
1) Cargo (boxes, TVs, fishing poles, other hard surfaced gear) scratching the door's interior when moving around during travel
2) Water and mud on the door's interior when passengers or pets are soiled and rub up against a vehicle's doors
3) Wear and tear from, for example, a dog's hard nails scratching against the vehicle's door when they jump up against the interior of the door when they look outside (especially when they see something that gets them excited or agitated)
4) Slobber and other fluids soiling the seats when a dog is up against the door's interior
5) Blood or other bodily fluids staining the doors of a police officer's cruiser when transporting injured or ill people
6) Drinks or food soiling the interior surface of the door when spilled by passengers during travel

In the past, towels and blankets have been employed to address some of these issues, but these solutions may have their own problems, making them potentially less than ideal solutions for protecting the interior surfaces of a vehicle's door. For example, towels and blankets can be placed between the cargo and the doors when transporting cargo, but they may not always be reliable protectors since they can possibly dislodge when cargo moves around and thus no longer provide a protective barrier. Further, attempting to secure the blanket or towel within the doorframe itself, to prevent incidental dislodging, can result in severely smashed fingers.

Past attempts at solutions include a protective device that has a means for attaching a top upper portion of a piece of fabric to the top of the door's interior (at the base of the window) so that the fabric can hang down inside the car covering the interior door and provide a protective barrier. This solution, however, is much like a cape, secured at the top but not elsewhere, and is prone to flapping in the breeze. It is also prone to dislodging by contact, since it is only secured at one point. Thus, it is possible for the lower portion of the device to potentially be pushed aside during movement of cargo or possibly even come off (such as when pushed upward and thus dislodging the upper securing mechanisms). When the window is down, wind from the outside of the moving vehicle can even possibly blow the device up and out the window.

The exemplary illustrative non-limiting implementations provide a comprehensive solution to address remaining problems associated with protecting the interior of a vehicle's doors. Various exemplary aspects of the illustrative implementations accomplish, among other things:
1. Protection of the interior of a vehicle's doors
2. Remaining in place once installed
3. Remaining in place when the vehicle's windows are open
4. Easy to install and remove

The exemplary illustrative non-limiting implementations can be made of any durable material such as nylon, vinyl, rubber or polyester fabric or a non-flexible material such as plastic, wood, or metal. Other suitable materials that will protect the door may also be used. The exemplary illustrative non-limiting implementations protect the interior of a vehicle's doors by extending down over the upholstered portion of the door, and are well secured at the upper and lower portion of the vehicle's interior door panel thus creating a protective barrier between the vehicle's door and the contents of the vehicle.

According to one exemplary implementation, in addition to being secured at an upper portion of the interior panel, such as into the window frame, the cover is also secured at one or more lower portions.

For example, in one exemplary implementation, the cover is provided with one or more magnets attached to one or more bottom straps thereof. These magnets are then placed into contact with the metal on the inner frame portions of the door, holding the cover in place. Once the door is closed, the pressure between the door frame and the car frame serves to additionally secure the cover in place.

As an alternative to one or more magnets, other fastening devices such as hook and loop fasteners, suction cups, etc. can be used to at least temporarily secure one or more straps arranged on a lower portion of a cover to the inside of the door frame.

Fasteners which are easy to disconnect can be used if it is desired to make the cover easily removable, and stronger fasteners, such as strong magnets or hooks can be used if it is desired to reduce the risk of the cover coming off when the door is opened. In either event, the pressure of the door against the car frame does much to hold the cover in place when the door is closed.

### BRIEF DESCRIPTION OF THE DRAWINGS

These and other features will be better and more completely understood by referring to the following detailed description of exemplary non-limiting illustrative embodiments in conjunction with the drawings of which:

FIGS. 1A & B show a plan view of an exemplary removable, vehicle interior door guard.

FIG. 2 shows a view of an exemplary removable, vehicle interior door guard;

FIG. 3 shows a close-up view of a temporary securing mechanism; and

FIG. 4 shows an additional view of an exemplary removable, vehicle interior door guard.

### DETAILED DESCRIPTION

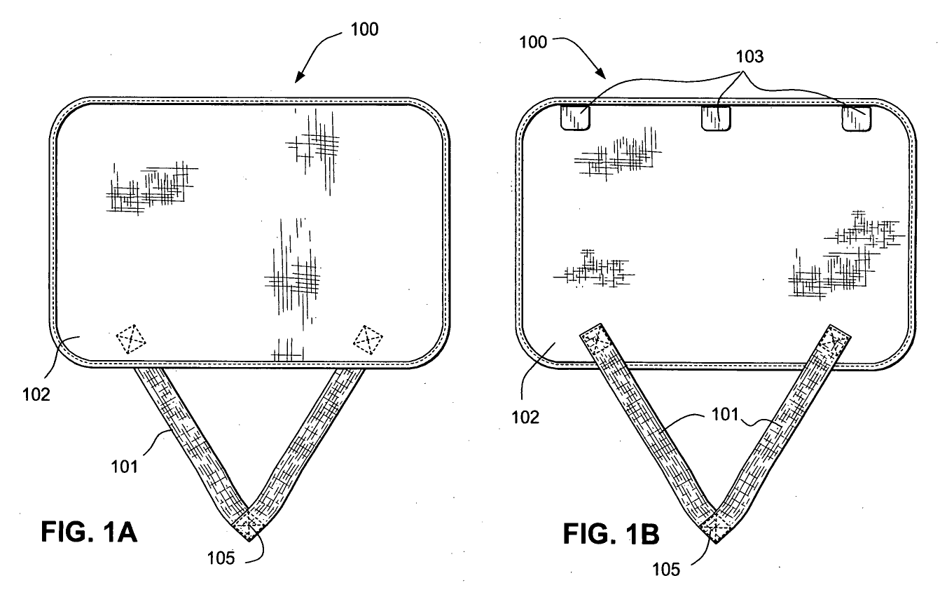

FIG. 1A shows an exemplary front plan view of an exemplary illustrative non-limiting implementation. In this implementation, the door guard itself 100 comprises a relatively rectangular piece of protective fabric 102. Attached to a bottom portion of the fabric are several retaining straps 101. At an intersection of the retaining straps, a magnet 105 is embedded between the straps. The magnet 105 is strong enough to stick to a metal door frame through the thickness of the strap.

Also, although only a single lower securing point 105 is shown here, more than one securing point can be provided for additional resistance to movement

FIG. 1B. shows an exemplary back plan view of the exemplary illustrative non-limiting implementation shown in FIG. 1A. Along an upper portion of the back side of the fabric 102, one or more securing fasteners 103 are provided. These fasteners 103 can be secured into the window well along the upper edge of an interior panel of a door.

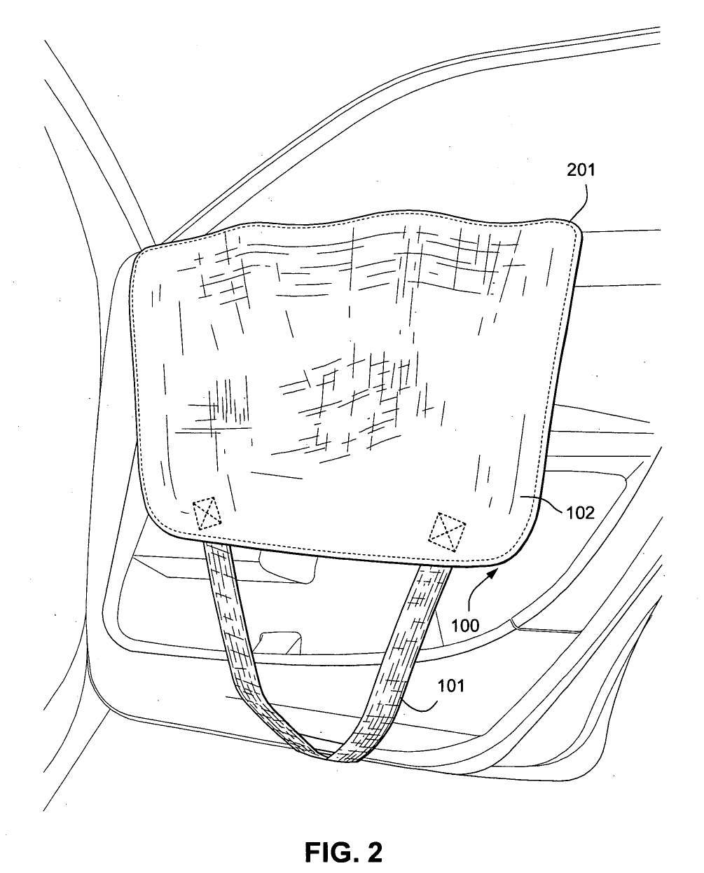

FIG. 2 is a view of an exemplary, non-limiting implementation wherein the primary barrier is made of a durable fabric 102 coated to provide a moisture barrier. The barrier is attached at the upper portion 201 of the vehicle's door using stiff, thin plastic inserts (not seen) that are attached to the main barrier's fabric portion 102. The inserts are designed so that they can be, for example, inserted in the gap between the vehicle's glass window and the interior wall of the vehicle's door. The lower portion of the main barrier portion is held temporarily in place by a magnet on the end of securing straps 101. The barrier is held securely in place when by the pressure of the vehicle's door when closed combined with any weatherproofing systems surrounding a vehicle's door.

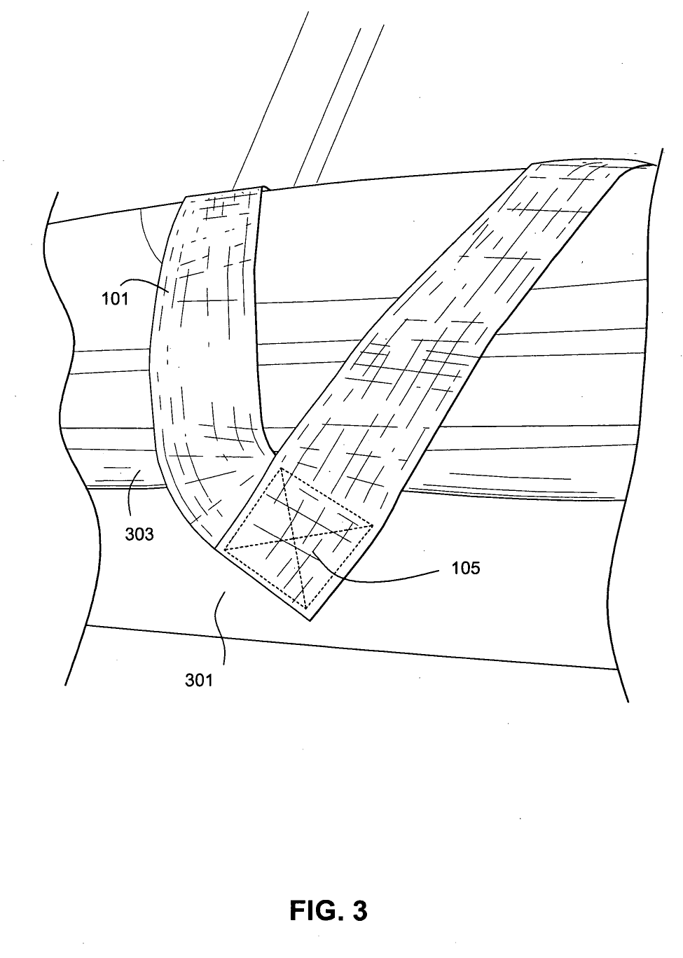

FIG. 3 shows a close up of an attachment point of a retaining strap 101. A magnet 105 (or other suitable retaining device) attached to the retaining strap 101 is pressed against a metal door frame 301. Additionally, the retaining strap passes over the weather-stripping 303 on the vehicle door. When the vehicle door is closed, the weather-stripping is pressed securely against the vehicle frame, and the retaining strap 101 is further secured in place, even if the magnet 105 comes loose.

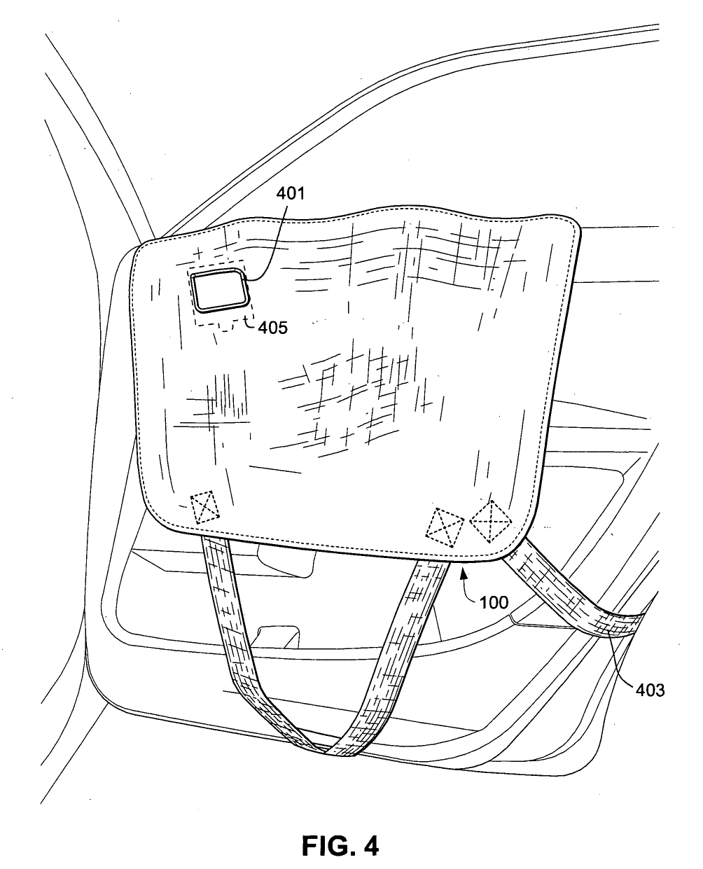

FIG. 4 shows an alternative exemplary illustrative implementation. In this implementation, there is an additional retaining strap 403 provided to give extra security to the attachment. As many retaining straps as are desired may be added. Also, a door handle access hole 401 has been provided so that the door can be opened from the inside while the cover 100 is in place. A securable protective flap 405 can also be provided to cover the opening so that an animal or small child cannot easily accidentally open the door.

One of the aspects of the exemplary, non-limiting implementations is that the lower securing mechanisms can be positioned while the door is open. This ensures that the cover will be secured at the proper fastening points, before the door is closed. Once the door is closed, the pressure of the vehicle's door upon the securing straps along with the resistance created by the vehicle door's weather stripping against the larger surface area of the securing mechanisms work together to firmly prevent the lower securing straps from moving around or coming off until the vehicle's door is opened. Any downward pressure on the protective barrier will not be able to move the barrier downwards since it is secured at the upper portion by, for example, the upper inserts that have been inserted between the vehicle's window glass and the inner wall of the vehicle's door. Any upward pressure on the protective barrier will not be able to move the barrier upwards since the lower portion of the barrier is secured by the pressure of the closed vehicle's door on the lower connecting straps. This configuration will also resist lateral pressure, and can be made to further resist lateral pressure by the addition of one or more extra strap provided in at least a semi lateral direction.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

I claim:

1. A removable protective vehicle door cover comprising:
a protective barrier;
one or more upper fasteners for securing an upper portion of the protective barrier to an upper portion of an interior vehicle door;
one or more lower fasteners for securing a lower portion of the protective barrier to a lower portion of an interior vehicle door, such that the fastener's hold the lower portion at least temporarily in place until the vehicle door is closed, at which point the pressure of the vehicle door against a car frame grips the fasteners and securely holds the protective-barrier in place.

2. The door cover of claim 1, wherein the fasteners include one or more straps of high-tensile material and a securing device attached to a first end thereof, and wherein the other end thereof is attached to the barrier.

3. The door cover of claim 2, wherein the securing device comprises a magnet.

4. The door cover of claim 2, wherein the securing device comprises a hook and loop fastener.

5. The door cover of claim 2, wherein the securing device comprises a suction cup.

6. The door cover of claim 1, wherein the protective barrier includes a hole cut therein to allow access to a handle secured behind the barrier.

7. The door cover of claim 6, wherein the protective barrier includes a cover covering the hole.

8. The door cover of claim 7, wherein the cover is securable over the hole.

9. The door cover of claim 1, wherein the upper portion of the door is the window well.

10. A method for protecting a vehicle door interior, using a protective barrier including one or more upper fasteners and one or more lower fasteners comprising:
securing the one or more upper fasteners to an upper portion of the interior of the door;
securing the one or more lower fasteners to a lower portion of the door frame; and
closing the door to create a pressurized force on the one or more lower fasteners, the force coming from the pressure of the door against the vehicle frame and the force being sufficient to substantially hold the lower fasteners in place against pressure.
